(19) United States
(12) Patent Application Publication
(10) Pub. No.: US 2026/0352718 A1
(43) Pub. Date: Nov. 5, 2026

(54) Streaming Video Image Data from a Personal Electronic Device to a Communal Electronic Device

(71) Applicant: Apple Inc., Cupertino, CA (US)

(72) Inventors: Padmavathy Bhooma, Los Gatos, CA (US); Abhishek Nayyar, Sunnyvale, CA (US); Bradley D. Ford, San Jose, CA (US); Maxim Stepanov, Palo Alto, CA (US); Yu Xing, San Jose, CA (US); Zak C. Wegweiser, Redwood City, CA (US)

(21) Appl. No.: 19/488,044

(22) PCT Filed: May 31, 2024
(86) PCT No.: PCT/US2024/032103

§ 371 Date: Nov. 25, 2025

Related U.S. Application Data
(60) Provisional application No. 63/506,006, filed on Jun. 2, 2023.

(51) Int. Cl. H04L 65/403; H04L 65/1069; H04W 12/08; H04W 76/40

(52) U.S. Cl. CPC H04L 65/403; H04L 65/1069; H04W 12/08; H04W 76/40

(57) ABSTRACT

Techniques for the establishment and maintenance of secure audio/video data streaming connections between electronic devices, e.g., a personal electronic device and a communal electronic device, which devices are not necessarily associated with the same user account. For example, a first device (e.g., a communal electronic device) may enter into a first state of a peer device advertising protocol, detect a presence of a second device (e.g., a personal electronic device), and then initiate a streaming session between the devices. Once the session is initiated, the first device may periodically broadcast a first session state indicator, e.g., via a Bluetooth® Low Energy (BLE) advertising packet, indicating whether the session is currently active. The first device may also begin periodically receiving a second session state indicator from the second device, also indicating whether the session is currently active. The first device may maintain the session until a session disconnection criterion is satisfied.

### TECHNICAL FIELD

This disclosure relates generally to the field of audio and video data streaming. More particularly, but not by way of limitation, it relates to techniques for automatically establishing and maintaining secure connections between electronic devices, e.g., a personal electronic device and a communal electronic device, e.g., for the streaming of audio and/or video data.

### BACKGROUND

The advent of portable integrated computing devices has caused a wide proliferation of cameras and other video capture-capable devices. These integrated computing devices commonly take the form of smartphones, tablets, or laptop computers, and typically include general purpose computers, cameras, sophisticated user interfaces including touch-sensitive screens, and wireless communications abilities through Wi-Fi®, Bluetooth®, LTE, HSDPA, New Radio (NR), and other cellular-based or wireless technologies. The wide proliferation of these integrated devices provides opportunities to use the devices' capabilities to perform tasks that would otherwise require dedicated hardware and software. (BLUETOOTH® is a trademark of BLUETOOTH SIG, INC., and Wi-Fi® is a trademark of the Wi-Fi Alliance.)

For example, portable integrated computing devices, such as smartphones, tablets, and laptops typically have two or more embedded cameras. These cameras generally amount to lens/camera hardware modules that may be controlled through the use of a general-purpose computer using firmware and/or software (e.g., “Apps”) and a user interface, including touch-screen buttons, fixed buttons, and/or touchless controls, such as voice control. The integration of high-quality cameras into these portable integrated communication devices, such as smartphones, tablets, and laptop computers, has enabled users to capture and share images and videos in ways never before possible. It is now common for users' smartphones to be their primary image capture device of choice.

Along with the rise in popularity of photo and video sharing via portable integrated computing devices having integrated cameras has come a rise in videoconferencing via such portable integrated computing devices. In particular, users often engage in videoconferencing calls or meetings, with the video images typically captured by a front-facing camera on the device, i.e., a camera that faces in the same direction as the camera device's display screen. Most prior art cameras are optimized for either wide-angle, general photography or for narrower-angle photography, e.g., self-portraits and videoconferencing streaming use cases. Those cameras that are optimized for wide angles are typically optimized for group and landscape compositions, but are not optimal for individual portraits, due, e.g., to the distortion that occurs when subjects are at short distances from the camera or at the edges of the camera's field of view.

Cameras that are optimized for portraits and video conference streaming (e.g., “front-facing” cameras) are not typically optimal for landscapes and group photos (or group videoconferencing calls) because of their limited field of view. Moreover, the field of view of a given camera also may influence how the user composes the shot (i.e., how far away and at what angle they position themselves with respect to the device's camera) and the quality of the ultimately captured image. Additionally, certain devices that may be the most comfortable or appropriate for a user to utilize during a lengthy videoconferencing call, e.g., a desktop computer with a standalone monitor or a laptop computer, may either have no integrated camera or a low-quality, integrated web camera.

Thus, in order to provide users with greater flexibility in image capture sources—and the ability to leverage higher-quality image capture devices during videoconferencing sessions (e.g., via a camera that is integrated into one of their portable communication devices)—it would be desirable to have methods and systems that provide such users the ability to seamlessly and automatically create and maintain secure connections between their electronic devices, e.g., to allow for the streaming of audio and/or video image data that is captured by a first electronic device directly to a second electronic device for subsequent presentation, storage, or further transmission by the second electronic device. Ideally, such methods and systems should also have low power consumption, be resilient to interruptions and/or pauses in the audio and/or video streams being shared, and be flexible enough to allow secure connections between devices that are in proximity to one another-but that are not necessarily associated with a same user account.

### SUMMARY

Devices, methods, and non-transitory program storage devices (NPSDs) are disclosed herein to enable the establishment and maintenance of secure audio/video data streaming connections between electronic devices, e.g., a personal electronic device and a communal electronic device, which are not necessarily associated with a same user or a same user account. For example, a first method is disclosed herein, comprising: entering, at a first electronic device (e.g., a communal electronic device), into a first state of a peer device advertising protocol (e.g., BLUETOOTH® Low Energy or “BLE”); detecting a presence of a second electronic device (e.g., a personal electronic device) in proximity to the first electronic device while in the first state of the peer device advertising protocol; and initiating a first session between the first electronic device and the second electronic device via a secure wireless peer-to-peer connection protocol (e.g., a Wi-Fi®-based protocol).

Once the first session is initiated, the first electronic device may establish a software process (e.g., a daemon) that periodically broadcasts a first session state indicator via the peer device advertising protocol, wherein the first session state indicator indicates whether the first session is currently active. The first electronic device may also begin receiving, at the software process, a second session state indicator from the second electronic device via the peer device advertising protocol, wherein the second session state indicator indicates whether the first session is currently active. The first device may then maintain the first session until a session disconnection criterion is satisfied, wherein the session disconnection criterion is based, at least in part, on the first session state indicator or the second session state indicator.

According to some embodiments, the session disconnection criterion is satisfied when at least one of the following conditions occurs: (a) the first electronic device does not receive a second session state indicator indicating that the first session is currently active for greater than a first predetermined amount of time; (b) the first electronic device does not broadcast a first session state indicator indicating that the first session is currently active for greater than a second predetermined amount of time; (c) the first electronic device initiates a disconnection event for the first session; or (d) the first electronic device receives an indication of a disconnection event for the first session from the second electronic device.

According to other embodiments, the second electronic device comprises a first image capture device (e.g., a video camera), and the method further comprises: receiving, at the first electronic device during the first session, one or more images captured at the second electronic device by the first image capture device. According to some such embodiments, the one or more images received at the first electronic device are part of a video image stream captured at the second electronic device, and an interruption or pausing of the video image stream at the second electronic device does not satisfy the session disconnection criterion. According to other such embodiments, two or more applications executing on the first electronic device are configured to utilize the one or more images received at the first electronic device. According to still other such embodiments, the first electronic device and second electronic device are required to be located within a threshold distance of each other (e.g., within BLE and/or Wi-Fi range) during the receiving of the one or more images.

According to still other embodiments, the first session state indicator is broadcast within a manufacturer-specific data Advertisement Data (AD) structure of a BLE advertisement packet. According to some such embodiments, the first session state indicator is broadcast within a BLE advertisement packet comprising an authentication tag (authtag) identifying the first electronic device. According to some such embodiments, the first session state indicator comprises a 1-bit value or a 2-bit value.

According to some embodiments, the software process (e.g., daemon) is configured to periodically broadcast the first session state indicator, even if a display screen of the first electronic device is off (i.e., devices may only actively “scan” if their screens are on, but they may “advertise” even if their screens are off, e.g., if they presently are in a standby/sleep state). According to other embodiments, the first electronic device is configured to enter into the first state of the peer device advertising protocol in response to a launching of a device discovery user interface flow.

According to some embodiments, the secure wireless peer-to-peer connection protocol (e.g., Wi-Fi) is a different protocol than the peer device advertising protocol (e.g., BLE). According to other embodiments, initiating the first session between the first electronic device and the second electronic device may further comprise utilizing a QR code, a PIN pairing process, or other form of authentication mechanism that ensures that only devices that a user affirmatively approves of will be able to connect to their electronic device (even if such devices are not presently associated with a same user account, on a same wireless network, etc.).

According to some embodiments, the first electronic device and second electronic device are associated with a different user or a different user account. According to other embodiments, the first electronic device is not associated with any single user account.

Various electronic devices are also disclosed herein, e.g., an electronic device, comprising: a memory; a first image capture device; and one or more processors operatively coupled to the memory, wherein the one or more processors are configured to execute instructions causing the one or more processors to: initiate, at the electronic device, a first videoconferencing session; enter, at the electronic device, into a first state of a peer device advertising protocol; detect a presence of a second electronic device in proximity to the electronic device while in the first state of the peer device advertising protocol; initiate a first session by extending the first videoconferencing session to the second electronic device via a secure wireless peer-to-peer connection protocol; establish, at the electronic device, a software process that periodically broadcasts a first session state indicator via the peer device advertising protocol, wherein the first session state indicator indicates whether the first session is currently active; receive, at the software process of the electronic device, a second session state indicator from the second electronic device via the peer device advertising protocol, wherein the second session state indicator indicates whether the first session is currently active; and maintain the first session until a session disconnection criterion is satisfied, wherein the session disconnection criterion is based, at least in part, on the first session state indicator or the second session state indicator.

According to some such electronic device embodiments, the session disconnection criterion is satisfied when at least one of the following conditions occurs: (a) the electronic device does not receive a second session state indicator indicating that the first session is currently active for greater than a first predetermined amount of time; (b) the electronic device does not broadcast a first session state indicator indicating that the first session is currently active for greater than a second predetermined amount of time; (c) the electronic device initiates a disconnection event for the first session; or (d) the electronic device receives an indication of a disconnection event for the first session from the second electronic device.

According to other such electronic device embodiments, the one or more processors are further configured to execute instructions causing the one or more processors to: transmit, during the first session, one or more images captured by the first image capture device to the second electronic device.

Various non-transitory computer readable media are also disclosed herein, e.g., a non-transitory computer readable medium comprising computer readable instructions executable by one or more processors to: enter, at a first electronic device, into a first state of a peer device advertising protocol; detect a presence of a second electronic device in proximity to the first electronic device while in the first state of the peer device advertising protocol; initiate a first session between the first electronic device and the second electronic device via a secure wireless peer-to-peer connection protocol; receive, at the first electronic device during the first session, one or more images from a video image stream captured by a first image capture device of the second electronic device; establish, at the first electronic device, a software process that periodically broadcasts a first session state indicator via the peer device advertising protocol, wherein the first session state indicator indicates whether the first session is currently active; receive, at the software process of the first electronic device, a second session state indicator from the second electronic device via the peer device advertising protocol, wherein the second session state indicator indicates whether the first session is currently active; and maintain, at the first electronic device, the first session until a session disconnection criterion is satisfied, wherein the session disconnection criterion is based, at least in part, on the first session state indicator or the second session state indicator, and wherein an interruption or pausing of the video image stream at the second electronic device does not satisfy the session disconnection criterion.

Various other non-transitory computer readable media (CRM) embodiments are also disclosed herein. Such CRM are readable by one or more processors. Instructions may be stored on the CRM for causing the one or more processors to perform any of the embodiments disclosed herein. Various image processing and secure device connection methods are also disclosed herein, in accordance with the device and CRM embodiments disclosed herein.

### BRIEF DESCRIPTION OF THE DRAWINGS

FIG. 1 illustrates exemplary personal electronic devices attempting to establish a secure connection with a communal electronic device for streaming audio and video data, according to one or more embodiments.

FIG. 2 is an exemplary block diagram illustrating the establishment and maintenance of a secure connection between electronic devices for streaming audio and video data, according to one or more embodiments.

FIG. 3 is an exemplary process flow diagram illustrating the establishment and maintenance of a secure connection between electronic devices for streaming audio and video data, according to one or more embodiments.

FIG. 4 an exemplary process flow diagram illustrating the tearing down of a secure connection between electronic devices for streaming audio and video data, according to one or more embodiments.

FIG. 5 illustrates an exemplary enhanced BLE advertising packet, according to one or more embodiments.

FIG. 6 is a flow chart illustrating a method of establishing and maintaining a secure connection between electronic devices for streaming audio and video data, according to various embodiments.

FIG. 7 is a flow chart illustrating a method of “handing off” an active communication session from a first electronic device to a second electronic device and then maintaining a secure connection between the devices, according to various embodiments.

FIG. 8 is a block diagram illustrating a programmable electronic device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number.

Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

The various techniques disclosed herein enable the establishment and maintenance of secure audio/video data streaming connections between electronic devices, e.g., a personal electronic device and a communal electronic device, which devices are not necessarily associated with the same user account. For example, a first electronic device (e.g., a communal electronic device) may enter into a first state of a peer device advertising protocol, detect a presence of a second electronic device (e.g., a personal electronic device), and then initiate a session between the devices. Once the first session is initiated, the first electronic device may periodically broadcast a first session state indicator indicating whether the first session is currently active. The first electronic device may also begin receiving a second session state indicator from the second electronic device, also indicating whether the first session is currently active. The first device may maintain the first session until a session disconnection criterion is satisfied.

### Exemplary Device Setups for Attempting to Establish Secure Connections Between User Electronic Devices

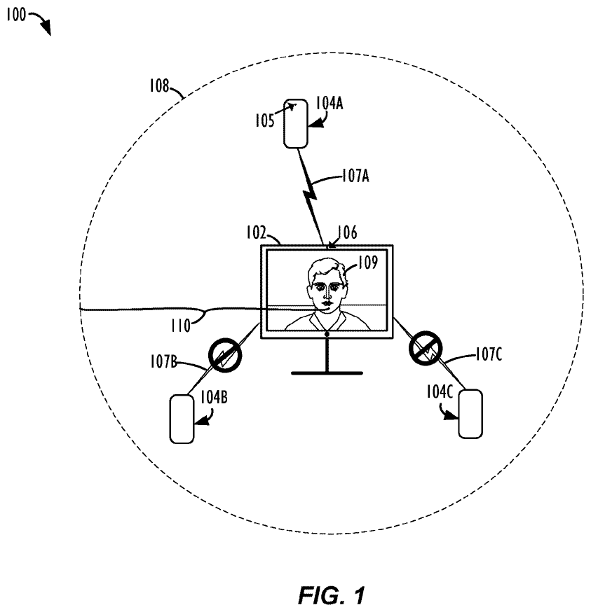

Turning now to FIG. 1, a scenario wherein multiple exemplary personal electronic devices 104A-104C are attempting to establish a secure connection 107 with a communal electronic device 102 for streaming audio and video data is illustrated. As shown in FIG. 1, communal electronic device 102 may comprise a “Smart TV” or other similar display device, and may comprise an embedded image capture device 106 (e.g., a “webcam,” or the like), which may be connected internally to the other components of device 102 and may be used to capture one or more exemplary images (109) of the scene surrounding device 102, e.g., including one or more human subjects.

Exemplary personal electronic device 104A may also have an embedded image capture device 105 (and may have one or more additional embedded image capture devices, as well). In some cases, an image capture device 105 of the personal electronic device 104A may be of a higher quality than the image capture device(s) 106 of the device 102, e.g., in terms of resolution, zoom, field of view (FOV), spatial resolution, focus, color quality, or any other imaging parameter. In such cases, it may be more desirable to use the image capture device 105 of the personal electronic device 104A rather than the image capture device 106 of the device 102 to capture images to be used, augmented, displayed, stored, transmitted, etc., by the device 102, e.g., as part of an active AV communication (e.g., videoconferencing) session.

In still other cases, a user of the device 102 may simply desire to select an image capture device of personal electronic device 104A for any number of other reasons, e.g., to provide a different (and/or additional) view of the scene around the device 102, because the device 102 may not have an image capture device of its own, because an image capture device of the device 102 is not functioning properly, because an image capture device of the personal electronic device 104A may have a special image capture feature or mode desired by the user of the second device (e.g., a “Portrait” or synthetic shallow depth of Field (SDOF) photography mode, a “Night” capture mode, a “Slow Motion” video capture mode, etc.), and so forth.

According to some embodiments, the communal electronic device 102 may only connect to personal electronic devices (e.g., personal electronic device 104A) that are in proximity to one another and attempting to form a secure wireless connection, e.g., wireless connection 107A, over an agreed-upon wireless connection protocol. As used herein, the term “in proximity to” may refer to devices that are within a discoverability distance of each other for a given wireless connection protocol, e.g., as illustrated by boundary circle 108, having a radius 110.

According to some implementations, measured signal strength may be used as a proxy for estimating the distance between two devices to determine if they are within a sufficiently close range of one another. In some such implementations, the threshold signal strength required for determining that two devices are within sufficiently close proximity to one another may not be a fixed threshold, and it also may be based on filtering (e.g., averaging) signal strength values over time across many signal strength samples.

In some embodiments, after successful connection, personal electronic device 104A could appear seamlessly alongside any other image capture sources available for selection within various applications at the device 102, e.g., alongside image capture devices that internal to (i.e., embedded in) device 102 (such as image capture device 106), or image capture devices connected directly to device 102 (e.g., via a USB port), and so forth.

In some embodiments, device 102 may form a secure connection session with only one personal electronic devices (e.g., personal electronic device 104A) at a time. Thus, as illustrated in FIG. 1, a second personal electronic device (i.e., personal electronic device 104B) is not presently able to establish a secure wireless connection 107B over the agreed-upon wireless connection protocol with device 102. Likewise, a third personal electronic device (i.e., personal electronic device 104C) is also not presently able to establish a secure wireless connection 107C over the agreed-upon wireless connection protocol with device 102.

As will be explained herein, the secure wireless connections between personal electronic devices (e.g., personal electronic devices 104B and 104C) may also be disconnected for various other reasons, such as: the device 102 not receiving a session state indicator (e.g., via BLE) from a personal electronic device 104, indicating that a streaming session is currently active for greater than a first predetermined amount of time; the device 102 not broadcasting a session state indicator (e.g., which may be received by any personal electronic devices 104 in its proximity) indicating that a streaming session is currently active for greater than a second predetermined amount of time; a user of device 102 affirmatively initiating a disconnection event for the session; and/or the device 102 receiving an indication of a disconnection event for the session from a personal electronic devices 104 in its proximity.

A streaming session may also bet disconnected for various other reasons, such as a device crashing, a software process managing the session and running on a device crashing, either device moving out of proximity range from one another, a device rebooting or going into a sleep/standby state, etc.

### Exemplary Block Diagram for Electronic Devices Establishing and Maintaining a Secure Connection

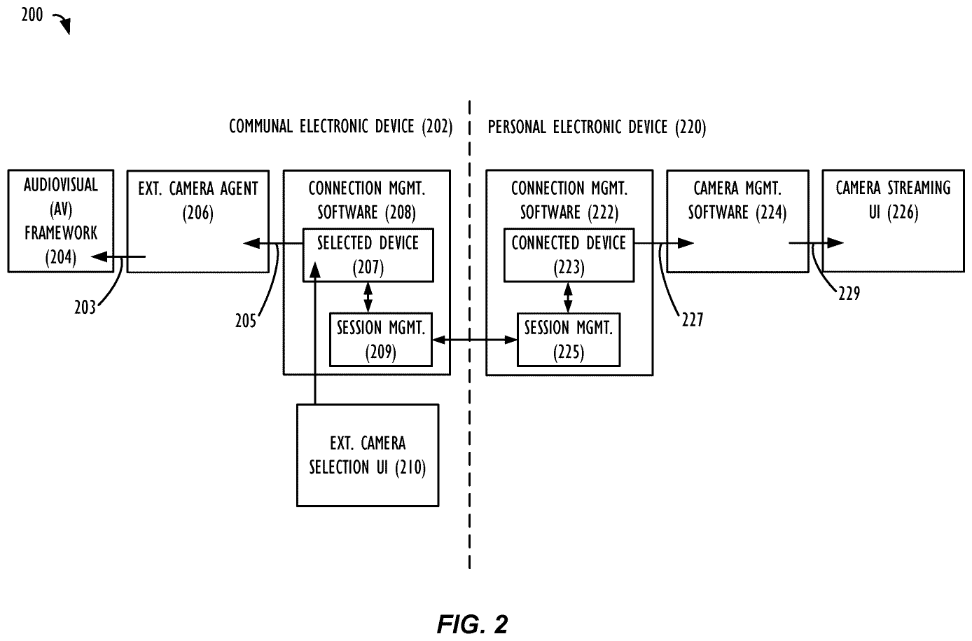

Turning now to FIG. 2, an exemplary block diagram 200 showing the establishment and maintenance of a secure connection between electronic devices 202 and 220 for streaming audio and video data is illustrated, according to one or more embodiments

Beginning with communal electronic device 202, communal electronic device 202 may comprise an audiovisual (AV) framework 204 that may serve as a framework for working with all time-based AV media consumed or played back at communal electronic device 202. Communal electronic device 202 may further comprise an external camera agent 206, which may publish (203) details of any/all external cameras that it is observing (or has registered) to the AV framework 204. Communal electronic device 202 may still further comprise a connection management software program 208 (which may, e.g., comprise a session management daemon). Connection management software 208 may serve various purposes, such as: maintaining the currently selected personal electronic device (207); and/or executing session management software (209) to handle the broadcasting/receiving of BLE advertising packets to other electronic devices, including the currently selected personal electronic device 207. The currently selected personal electronic device 207 may also observe (205) the external camera agent 206, e.g., such that the communal electronic device 202 remains updated with the list of device(s) that it is currently in connected streaming sessions with.

According to some embodiments, an external camera selection UI module (210) may be employed at communal electronic device 202, i.e., in order to allow users of communal electronic device 202 to select the desired external personal electronic device cameras with which they wish to establish secure steaming sessions.

Turning now to personal electronic device 220, personal electronic device 220 may comprise a connection management software program 222 (which may, e.g., be analogous to connection management software program 208 of communal electronic device 202 and/or comprise a session management daemon). Connection management software 222 may serve various purposes, such as: maintaining the currently connected personal electronic device (223); and/or executing session management software (225) to handle the broadcasting/receiving of BLE advertising packets to other electronic devices, including the communal electronic device 202.

The currently connected personal electronic device 223 may also observe (227) the camera management software 224, which may, in turn, enable (229) the personal electronic device 220 to remain updated with an accurate status of the currently connected personal electronic device, which it may present to a user, e.g., via camera streaming user interface software 226. Camera streaming user interface software 226 of personal electronic device 220 may allow a user to pause/resume streaming session, end streaming sessions, “hand off” video conferencing sessions to other devices, search for and connect to other communal electronic devices, etc.

In some embodiments, a peer device advertising protocol state may comprise a “default” or “low power” advertising state, which is configured to have a minimum advertising duty cycle and/or maximum time interval delay between the broadcasting of advertising packets. In other situations, e.g., if an eligible device is known (or predicted to be present nearby), the peer device advertising protocol state may enter into and “enhanced” or “high power” advertising state, which is configured to have a maximum permitted advertising duty cycle and/or minimum permitted time interval delay between the broadcasting of advertising packets. In some embodiments, a first device operating in the “enhanced” or “high power” mode of the peer device advertising protocol state may also cause another device in its proximity to enter into the enhanced peer device advertising state.

In some embodiments, an electronic device streaming AV content may be capable of detecting an interruption event (e.g., an incoming phone call, text message, email, or the like) and, in response to such detection, pausing the sending of images to a connected electronic device during the duration of the interruption event and, optionally, resuming the sending of images after the conclusion of the detected interruption event. In other embodiments, there may be a user interface option for a user to affirmatively indicate a desire to pause/interrupt an AV content sharing session, e.g., if the user needs to access functionality of the electronic device for some other reason.

### Exemplary Process Flow Diagrams Illustrating the Establishment, Maintenance, and Tearing Down of Secure Connections between Electronic Devices

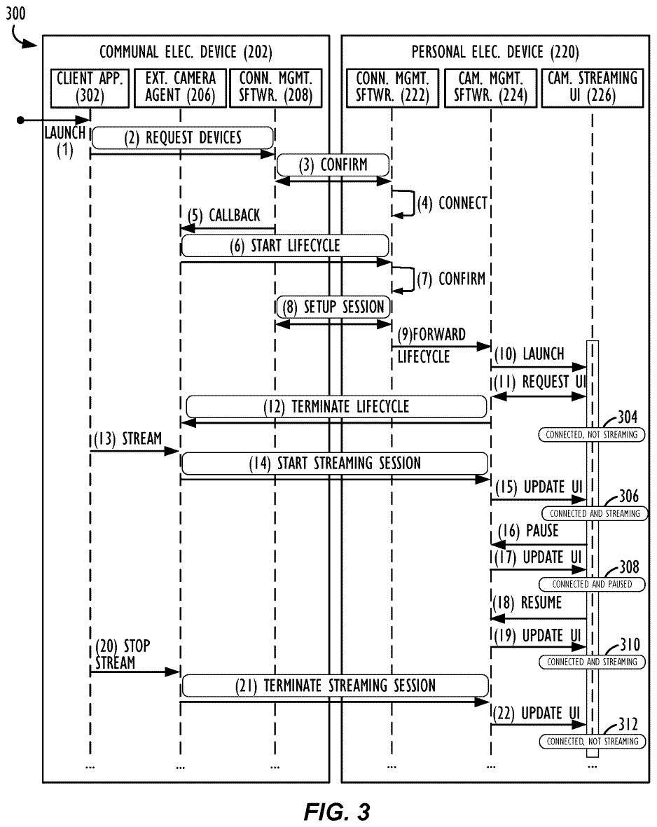

Turning now to FIG. 3, an exemplary process flow diagram 300 is shown, illustrating the establishment and maintenance of a secure connection between electronic devices for streaming audio and video data, according to one or more embodiments. In particular, diagram 300 details the processes and various interactions between an exemplary communal electronic device 202 and an exemplary personal electronic device 220 engaged in the establishment and maintenance of a secure streaming session.

Turning first to communal electronic device 202, which may comprise: a client application 302, e.g., used by the communal electronic device 202 to search for, connect with, and stream AV content from personal electronic devices, such as personal electronic device 220. Communal electronic device 202 may further comprise an external camera agent 206 and connection management software 208 (which may comprise a session management daemon), such as were described above with reference to FIG. 2. Turning next to personal electronic device 220, which may comprise: connection management software 222 (which may comprise a session management daemon), camera management software 224, and camera streaming user interface software 226, such as were described above with reference to FIG. 2.

Exemplary process flow diagram 300 may begin at Step (1), with a user of communal electronic device 202 indicating a desire to launch an application for establishing and maintaining secure connections between electronic devices for streaming audio and video data. Next, at Step (2), the client application 302 may request a list of discoverable electronic devices (e.g., personal electronic devices) from connection management software 208. Next, at Step (3), the connection management software 208 from the communal electronic device 202 may confirm the existence of personal electronic device 220 via personal electronic device 220′s connection management software 222. At Step (4), connection management software 222 may register communal electronic device 202 as a connected device.

Moving now to Step (5), the connection management software 208 may send a callback message to external camera agent 206 to confirm that an electronic device has been selected. Next, at Step (6), external camera agent 206 may start a session lifecycle with connection management software 222 at the personal electronic device 220, which the connection management software 222 may confirm as a valid connection, at Step (7).

At Step (8), the communal electronic device 202 and personal electronic device 220 may officially set up the advertising broadcasting/receiving framework used to monitor and maintain the connected session, such as those sessions that have been described herein, e.g., sessions leveraging BLE advertising packets and protocols to monitor and maintain secure streaming sessions between devices that are not necessarily associated with a same user account.

At Step (9), connection management software 222 may forward the session lifecycle information to camera management software 224, which may then, at Step (10), launch the camera streaming user interface software 226 at the personal electronic device 220.

In a first example, the camera management software 224 of personal electronic device 220 may request a UI state from the camera streaming user interface software 226. In this first example, the camera management software 224 may, at Step (12), transmit a message to the external camera agent 206 of the communal electronic device 202, indicating a desire to terminate the current session lifecycle. At that time, the personal electronic device 220 will be in a state (304) where it is still connected to communal electronic device 202, but it not presently streaming content to communal electronic device 202 (e.g., a user of communal electronic device 202 or of personal electronic device 220 may have changed applications, paused the streaming session, temporarily gone into a settings menu on their device, etc.). This state will allow the devices to rapidly re-establish content streaming, whenever either of the devices is ready to do so.

In a second example, at Step (13), the client application 302 at communal electronic device 202 may indicate a desire to resume streaming content with the personal electronic device 220. Thus, at Step (14), external camera agent 206 may send a message to the camera management software 224 to confirm that personal electronic device 220 should resume streaming data. Camera management software 224 may, at Step (15), transmit a message to the camera streaming user interface software 226, indicating a desire to update the UI to reflect that the streaming session has been resumed and is active again. At that time, the personal electronic device 220 will be in a state (306) where it is connected to communal electronic device 202 and is presently streaming content to communal electronic device 202.

In a third example, at Step (16), the camera streaming user interface software 226 may receive an indication of a desire to pause streaming content to the communal electronic device 202. Thus, at Step (17), camera management software 224 may transmit a message to the camera streaming user interface software 226, indicating a desire to update the UI to reflect that the streaming session has been paused. At that time, the personal electronic device 220 will be in a state (308) where it is connected to communal electronic device 202, but the streaming content to communal electronic device 202 is (temporarily) paused.

In a fourth example, at Step (18), the camera streaming user interface software 226 may receive an indication of a desire to resume a paused content stream to the communal electronic device 202. Thus, at Step (19), camera management software 224 may transmit a message to the camera streaming user interface software 226, indicating a desire to update the UI to reflect that the streaming session has resumed. At that time, the personal electronic device 220 will be in a state (310) where it is connected to communal electronic device 202, and is again streaming content to communal electronic device 202.

In a fifth example, at Step (20), the client application 302 at communal electronic device 202 may indicate a desire to stop the streaming content with the personal electronic device 220. Thus, at Step (21), external camera agent 206 may send a message to the camera management software 224 to terminate the streaming session. Camera management software 224 may, at Step (22), transmit a message to the camera streaming user interface software 226, indicating a desire to update the UI to reflect that the streaming session has been terminated. At that time, the personal electronic device 220 will be in a state (312) where it is connected to communal electronic device 202 but is not presently streaming content to communal electronic device 202.

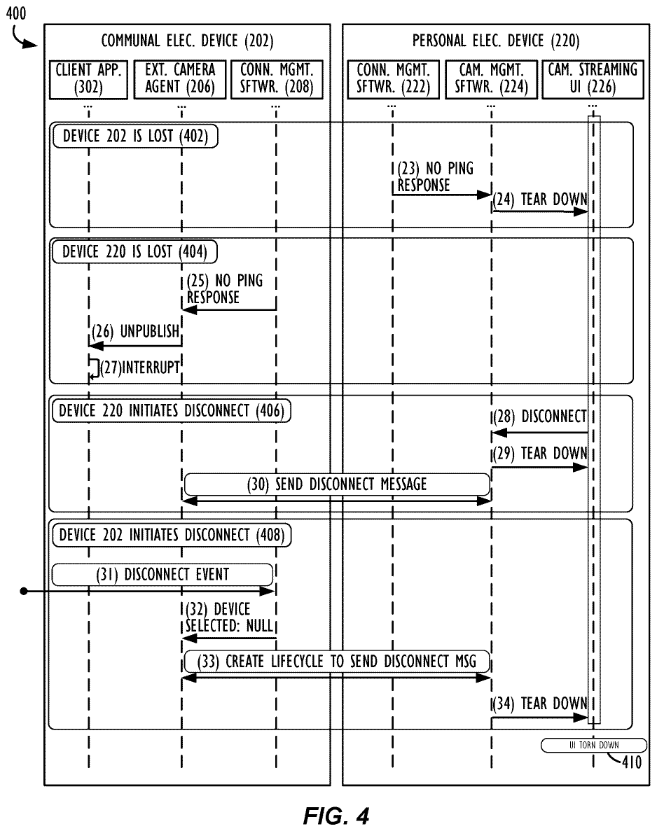

Turning now to FIG. 4, an exemplary process flow diagram 400 is shown, illustrating the tearing down of a secure connection between electronic devices for streaming audio and video data, according to one or more embodiments. As may be appreciated, FIG. 4 and exemplary process flow diagram 400 continues the process described above with respect to FIG. 3 and exemplary process flow diagram 300, and involves similar components, such as: client application 302, external camera agent 206, connection management software 208, connection management software 222, camera management software 224, and camera streaming user interface software 226, while focusing on the tearing down of connection sessions (as opposed to their establishment and maintenance, described above with reference to FIG. 3).

In a first exemplary tear down process flow 402 (wherein communal electronic device 202 is the device that becomes lost) the flow 402 may begin at Step (23), wherein connection management software 222 detects that there has been no responsive session state indictor received at personal electronic device 220 for greater than a predetermined amount of time and/or an incorrect or invalid session state indicator was received. This may indicate that the communal electronic device 202 has gone out of range, rebooted, or otherwise experienced a crash in one or more of its relevant connection management software processes. As such, flow 402 may proceed to Step (24) and tear down the connection session and the camera streaming user interface software 226.

In a second exemplary tear down process flow 404 (wherein personal electronic device 220 is the device that becomes lost) the flow 404 may begin at Step (25), wherein connection management software 208 detects that that there has been no responsive session state indictor received at communal electronic device 202 for greater than a predetermined amount of time. This may indicate that the personal electronic device 220 has gone out of range, rebooted, or otherwise experienced a crash in one or more of its relevant connection management software processes. As such, flow 404 may proceed to Step (26) to officially unpublish/disconnect personal electronic device 220 and, if desired, at Step (27), indicate to a user of communal electronic device 202 that the connection with personal electronic device 220 has been interrupted and allow the user of communal electronic device 202 to see if there are any other personal electronic devices within proximity and ready to form a secure streaming connection.

In a third exemplary tear down process flow 406 (wherein personal electronic device 220 initiates a disconnection event) the flow 406 may begin at Step (28), wherein user interface software 226 sends an indication to camera management software 224 that a user of personal electronic device 220 has initiated a disconnection event. Camera management software 224 may proceed, at Step (29) by tearing down the session at an appropriate time, so as not to cause undue disruption on either electronic device. Finally, at Step (30), a connection may be formed between camera management software 224 and external camera agent 206, so that personal electronic device 220 can indicate that the session has been affirmatively disconnected.

In a fourth exemplary tear down process flow 408 (wherein communal electronic device 202 initiates a disconnection event) the flow 408 may begin at Step (31), wherein connection management software 208 receives an indication that a user of communal electronic device 202 has initiated a disconnection event (e.g., by a user selecting a disconnection option in the device UI, switching to be connected to a different personal electronic device, being “handed off” a videoconferencing session from a different personal electronic device, going into a sleep/standby state, etc.). Next, at Step (32), connection management software 208 may notify external camera agent 206 that the personal electronic device 220 is no longer connected. Finally, at Step (33), a connection may be formed between external camera agent 206 and camera management software 224, so that communal electronic device 202 can indicate that the session has been affirmatively disconnected. At Step (34), camera management software 224 may proceed to tear down the session at personal electronic device 220.

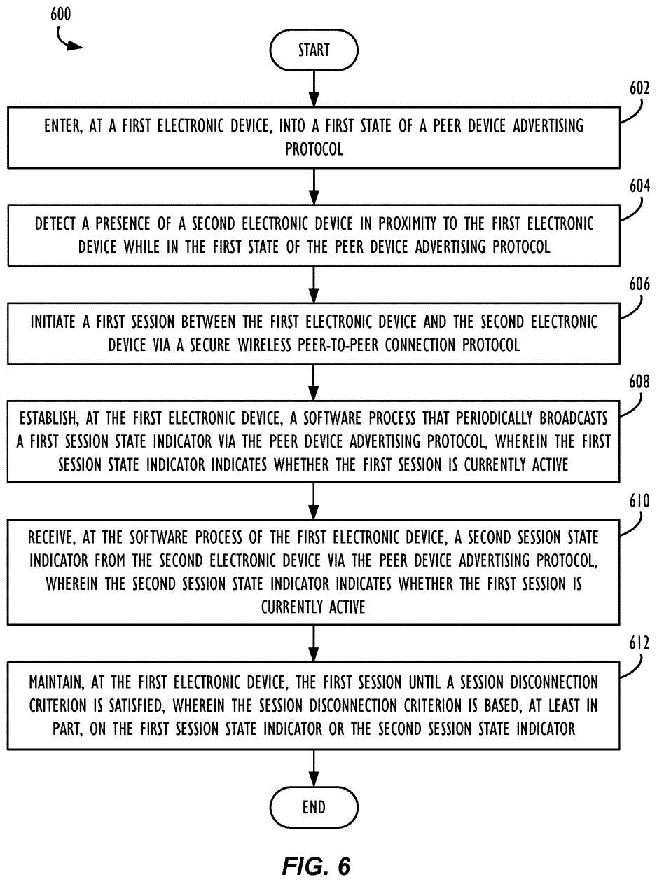

At the conclusion of any of the above-described exemplary tear down process flows illustrated in FIG. 6, the end result is that the content streaming UI will be in a state (410), where it no longer indicates that there is an active streaming or sharing session at personal electronic device 220.

### Exemplary Enhanced BLE Advertising Packets

As introduced above, BLUETOOTH® Low Energy or “BLE” is a 2.4 GHz industrial, scientific, and medical (ISM) band radio communication standard, originally introduced in 2010. BLE operates on 40 physical channels: 3 of those channels are dedicated to the discovery mechanism, also called “advertisement,” while the 37 remaining channels are used for data transmission. The advertisement discovery mechanism in BLE allows BLE-enabled devices to advertise their presence and characteristics to nearby devices. It relies on the broadcasting of advertisement packets on the 3 advertisement channels of BLE.

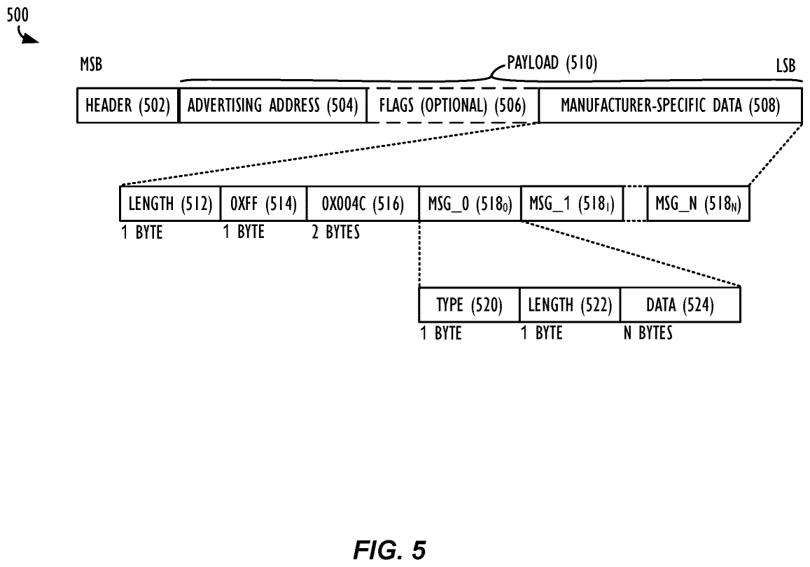

FIG. 5 illustrates an exemplary enhanced BLE advertising packet 500, according to one or more embodiments. Exemplary packet 500 is shown as being organized from left to right, beginning with the most-significant bit (MSB) and ending with the least-significant bit (LSB). According to some embodiments, packet 500 may begin with a typical header field (502), which may be, e.g., a 2-byte header field and used to store the length of the payload field (510) and/or other relevant metadata for the packet 500.

The payload field (510) contains an advertising device address (504) and up to 31 bytes of additional data, which are organized into Advertisement Data (AD) structures that carry information about the advertising device. An AD structure (such as Manufacturer Specific Data AD structure 508, illustrated in FIG. 5) may be composed of a 1-byte field (512) indicating the length of the AD (excluding itself), followed by a 1-byte field (514) specifying the type of the AD and, finally, a sequence of up to 29 bytes of data.

As mentioned above, one AD structure type, called Manufacturer Specific Data (represented by code 0xFF, as shown in 514), is dedicated to the transport of data for custom applications defined by the manufacturer. A Manufacturer Specific Data AD structure may begin with a company identifier (e.g., 0x004C, in the case of Apple Inc., as shown in 516), followed by one or several messages 518₀-518_{N} (e.g., messages related to the content sharing techniques described herein). Messages 518 may be stored in the Type-Length-Value (TLV) format, i.e., storing a type field (520), followed by a length field (522) indicating how long the message is, and then a data field (524) storing the actual data for the particular message 518. [Flags (506) is an optional AD structure for storing various programmatic flag values that is not required or used by all BLE protocols.]

In some embodiments, it may be beneficial to store session state indicator information within one or more bits that are transmitted as part of a BLE advertising packet, e.g., within a Manufacturer Specific Data AD structure. Benefits of such an approach may include: that the session state indicator will always (i.e., with a regular cadence) be advertised; that the identification transmitted in the advertising packets will take care of situations when the BLE address of one or more devices rotates over time; and/or that there will be no additional power or performance costs imposed on the electronic device, i.e., since the BLE advertising protocol will already be being performed by the electronic device.

One potential drawback of using a 1-bit or 2-bit broadcast session state indicator is that it may not convey enough information to indicate which device the broadcasting device is currently in an active streaming session with, but, this drawback may be overcome if the connection management software is configured to always confirm when a particular electronic device enters (or exits) a session. In that way, the device will know that, as long as a session is “active,” the device that it is in the session with is the same device that was indicated when the session initially began.

### Exemplary Methods of Establishing and Maintaining Secure Connections Between Devices for Streaming Audio and Video Data

FIG. 6 is a flow chart 600, illustrating a method of establishing and maintaining a secure connection between electronic devices for streaming audio and video data (from the perspective of a communal electronic device), according to various embodiments. First, at Step 602, the method 600 may enter, at a first electronic device, into a first state of a peer device advertising protocol. Next, at Step 604, the method 600 may detect a presence of a second electronic device in proximity to the first electronic device while in the first state of the peer device advertising protocol.

Next, at Step 606, the method 600 may initiate a first session between the first electronic device and the second electronic device via a secure wireless peer-to-peer connection protocol.

Next, at Step 608, the method 600 may establish, at the first electronic device, a software process (e.g., a daemon or other background process) that periodically broadcasts a first session state indicator via the peer device advertising protocol, wherein the first session state indicator indicates whether the first session is currently active

Next, at Step 610, the method 600 may receive, at the software process of the first electronic device, a second session state indicator from the second electronic device via the peer device advertising protocol, wherein the second session state indicator indicates whether the first session is currently active.

Finally, at Step 612, the method 600 may maintain, at the first electronic device, the first session until a session disconnection criterion is satisfied, wherein the session disconnection criterion is based, at least in part, on the first session state indicator or the second session state indicator. For example, according to some embodiments, the session may be maintained until either the first session state indicator or the second session state indicator times out or indicates (e.g., having a value of ‘0’ if a 1-bit session state indicator is being used) that the devices are no longer in a secure connected session. As described above, during some sessions, various forms of AV content may be streamed from the first electronic device to the second electronic device for display and/or reproduction. In some implementations, a temporary pausing or interruption of the AV content streaming (either intentional or unintentional) may not satisfy the streaming criterion meaning that, e.g., each device involved in the streaming session may continue to broadcast session state indicators indicating that the session is still active. Examples of situations that may, on the other hand, satisfy the session disconnection criterion are described above with reference to FIG. 4.

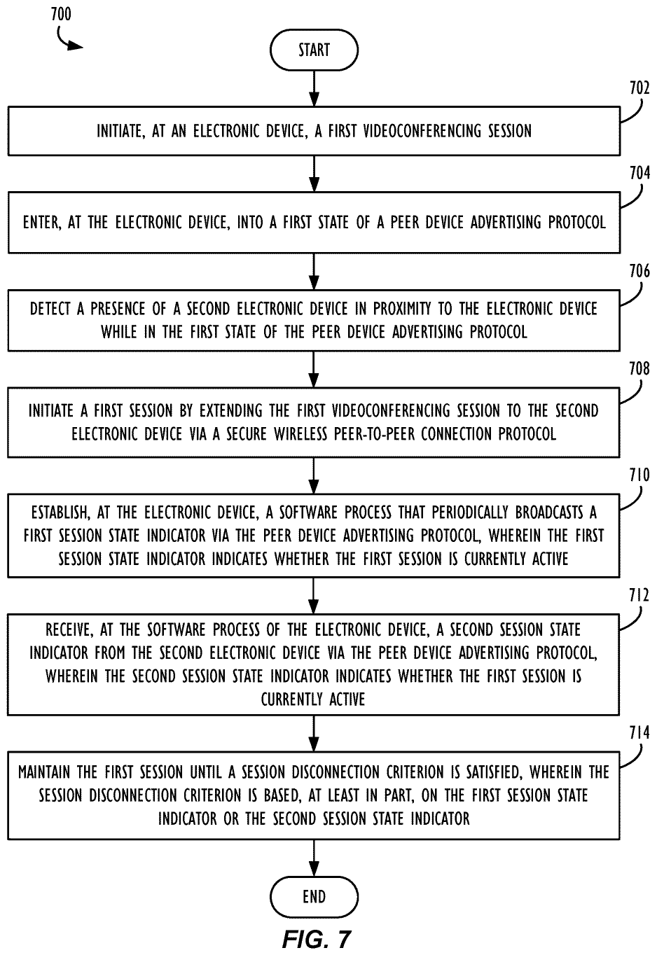

Turning now to FIG. 7, a flow chart 700, illustrating a method of “handing off” an active communication session (e.g., an audiovisual communication session) from a first electronic device (e.g., a personal electronic device) to a second electronic device (e.g., a communal electronic device) and then maintaining a secure connection between the devices, according to various embodiments. First, at Step 702, the method 700 may initiate, at a first electronic device, a first videoconferencing session. Next, at Step 704, the method 700 may cause the first electronic device to enter into a first state of a peer device advertising protocol.

Next, at Step 706, the method 700 may detect a presence of a second electronic device in proximity to the first electronic device while in the first state of the peer device advertising protocol.

Next, at Step 708, the method 700 may initiate a first session by extending the first videoconferencing session to the second electronic device via a secure wireless peer-to-peer connection protocol. As described above, according to some embodiments, of “handing off” an active communication session may more accurately be described as an act of “extending” an active communication session to another device. For example, according to method 700, a personal electronic device presently engaged in an active communication session may continually extend its identity (and use of its one or more image capture devices) to another (e.g., communal) electronic device, such as a “Smart TV,” or the like. In such an embodiment, the user's personal electronic device may still be orchestrating the active communication session (and may even remain as an active device in the active communication session), even after it has “extended” its identify to the communal electronic device.

Next, at Step 710, the method 700 may establish, at the electronic device, a software process that periodically broadcasts a first session state indicator via the peer device advertising protocol, wherein the first session state indicator indicates whether the first session is currently active.

Next, at Step 712, the method 700 may receive, at the software process of the electronic device, a second session state indicator from the second electronic device via the peer device advertising protocol, wherein the second session state indicator indicates whether the first session is currently active.

Finally, at Step 714, the method 700 may maintain the first session until a session disconnection criterion is satisfied, wherein the session disconnection criterion is based, at least in part, on the first session state indicator or the second session state indicator. For example, according to some embodiments, the session may be maintained until either the first session state indicator or the second session state indicator times out or indicates (e.g., having a value of ‘0’ if a 1-bit session state indicator is being used) that the devices are no longer in a secure connected session. As described above, during some sessions, various forms of AV content may be streamed from the first electronic device to the second electronic device for display and/or reproduction.

As may be appreciated, the various methods described herein, e.g., with reference to FIGS. 6 and 7, may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s).

### Exemplary Electronic Devices

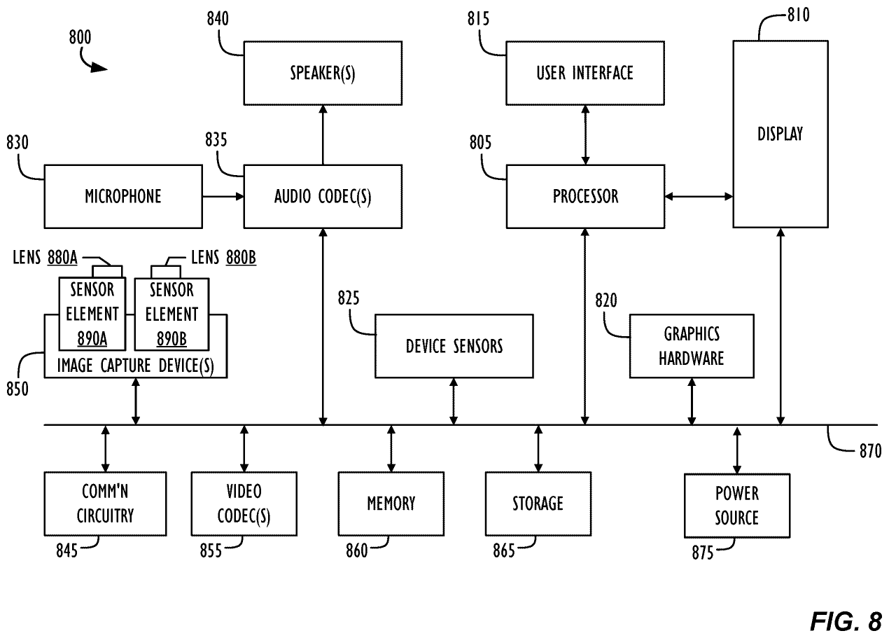

Referring now to FIG. 8, a simplified functional block diagram of illustrative programmable electronic device 800 is shown according to one embodiment. Electronic device 800 could be, for example, a mobile telephone, personal media device, portable camera, or a tablet, notebook or desktop computer system. As shown, electronic device 800 may include processor 805, display 810, user interface 815, graphics hardware 820, device sensors 825 (e.g., proximity sensor/ambient light sensor, accelerometer, inertial measurement unit, and/or gyroscope), microphone 830, audio codec(s) 835, speaker(s) 840, communications circuitry 845, image capture device 850, which may, e.g., comprise multiple camera units/optical image sensors having different characteristics or abilities (e.g., Still Image Stabilization (SIS), HDR, OIS systems, optical zoom, digital zoom, etc.), video codec(s) 855, memory 860, storage 865, and communications bus 870.

Processor 805 may execute instructions necessary to carry out or control the operation of many functions performed by electronic device 800 (e.g., such as the generation, processing, and/or streaming of audio and/or video data in accordance with the various embodiments described herein). Processor 805 may, for instance, drive display 810 and receive user input from user interface 815. User interface 815 can take a variety of forms, such as a button, keypad, dial, a click wheel, keyboard, display screen and/or a touch screen. User interface 815 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 810 may display a video stream as it is captured while processor 805 and/or graphics hardware 820 and/or image capture circuitry contemporaneously generate and store the video stream in memory 860 and/or storage 865. Processor 805 may be a system-on-chip (SOC) such as those found in mobile devices and include one or more dedicated graphics processing units (GPUs). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 perform computational tasks. In one embodiment, graphics hardware 820 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 850 may comprise one or more camera units configured to capture images, e.g., images which may be processed to generate framed and/or distortion-corrected versions of said captured images, e.g., in accordance with this disclosure. Image capture device(s) 850 may include two (or more) lens assemblies 880A and 880B, where each lens assembly may have a separate focal length. For example, lens assembly 880A may have a shorter focal length relative to the focal length of lens assembly 880B. Each lens assembly may have a separate associated sensor element, e.g., sensor elements 890A/890B. Alternatively, two or more lens assemblies may share a common sensor element. Image capture device(s) 850 may capture still and/or video images. Output from image capture device 850 may be processed, at least in part, by video codec(s) 855 and/or processor 805 and/or graphics hardware 820, and/or a dedicated image processing unit or image signal processor incorporated within image capture device 850. Images so captured may be stored in memory 860 and/or storage 865.

Memory 860 may include one or more different types of media used by processor 805, graphics hardware 820, and image capture device 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805, such computer program code may implement one or more of the methods or processes described herein. Power source 875 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 800.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method, comprising:
entering, at a first electronic device, into a first state of a peer device advertising protocol;
detecting a presence of a second electronic device in proximity to the first electronic device while in the first state of the peer device advertising protocol;
initiating a first session between the first electronic device and the second electronic device via a secure wireless peer-to-peer connection protocol;
establishing, at the first electronic device, a software process that periodically broadcasts a first session state indicator via the peer device advertising protocol, wherein the first session state indicator indicates whether the first session is currently active;
receiving, at the software process of the first electronic device, a second session state indicator from the second electronic device via the peer device advertising protocol, wherein the second session state indicator indicates whether the first session is currently active; and
maintaining, at the first electronic device, the first session until a session disconnection criterion is satisfied, wherein the session disconnection criterion is based, at least in part, on the first session state indicator or the second session state indicator.

2. The method of claim 1, wherein the session disconnection criterion is satisfied when at least one of the following conditions occurs:
(a) the first electronic device does not receive a second session state indicator indicating that the first session is currently active for greater than a first predetermined amount of time;
(b) the first electronic device does not broadcast a first session state indicator indicating that the first session is currently active for greater than a second predetermined amount of time;
(c) the first electronic device initiates a disconnection event for the first session; or
(d) the first electronic device receives an indication of a disconnection event for the first session from the second electronic device.

3. The method of claim 1, wherein the second electronic device comprises a first image capture device, the method further comprising:
receiving, at the first electronic device during the first session, one or more images captured at the second electronic device by the first image capture device.

4. The method of claim 3, wherein the one or more images received at the first electronic device are part of a video image stream captured at the second electronic device, and wherein an interruption or pausing of the video image stream at the second electronic device does not satisfy the session disconnection criterion.

5. The method of claim 3, wherein two or more applications executing on the first electronic device are configured to utilize the one or more images received at the first electronic device.

6. The method of claim 3, wherein the first electronic device and second electronic device are required to be located within a threshold distance of each other during the receiving of the one or more images.

7. The method of claim 1, wherein the peer device advertising protocol comprises a Bluetooth Low Energy (BLE) advertising protocol.

8. The method of claim 7, wherein the first session state indicator is broadcast within a manufacturer-specific data Advertisement Data (AD) structure of a BLE advertisement packet.

9. The method of claim 7, wherein the first session state indicator is broadcast within a BLE advertisement packet comprising an authentication tag (authtag) identifying the first electronic device.

10. The method of claim 7, wherein the first session state indicator comprises a 1-bit value or a 2-bit value.

11. The method of claim 1, wherein the software process is configured to periodically broadcast the first session state indicator, even if a display screen of the first electronic device is off.

12. The method of claim 1, wherein the first electronic device is configured to enter into the first state of the peer device advertising protocol in response to a launching of a device discovery user interface flow.

13. The method of claim 1, wherein the secure wireless peer-to-peer connection protocol is a different protocol than the peer device advertising protocol.

14. The method of claim 1, wherein the first electronic device and second electronic device are associated with a different user or a different user account.

15. The method of claim 1, wherein the first electronic device is not associated with any single user account.

16. The method of claim 1, wherein initiating the first session between the first electronic device and the second electronic device comprises utilizing a QR code or a PIN pairing process.

17. An electronic device, comprising:
a memory;
a first image capture device; and
one or more processors operatively coupled to the memory, wherein the one or more processors are configured to execute instructions causing the one or more processors to:
initiate, at the electronic device, a first videoconferencing session;
enter, at the electronic device, into a first state of a peer device advertising protocol;
detect a presence of a second electronic device in proximity to the electronic device while in the first state of the peer device advertising protocol;
initiate a first session by extending the first videoconferencing session to the second electronic device via a secure wireless peer-to-peer connection protocol;
establish, at the electronic device, a software process that periodically broadcasts a first session state indicator via the peer device advertising protocol, wherein the first session state indicator indicates whether the first session is currently active;
receive, at the software process of the electronic device, a second session state indicator from the second electronic device via the peer device advertising protocol, wherein the second session state indicator indicates whether the first session is currently active; and
maintain the first session until a session disconnection criterion is satisfied, wherein the session disconnection criterion is based, at least in part, on the first session state indicator or the second session state indicator.

18. The electronic device of claim 17, wherein the session disconnection criterion is satisfied when at least one of the following conditions occurs:
(a) the electronic device does not receive a second session state indicator indicating that the first session is currently active for greater than a first predetermined amount of time;
(b) the electronic device does not broadcast a first session state indicator indicating that the first session is currently active for greater than a second predetermined amount of time;
(c) the electronic device initiates a disconnection event for the first session; or
(d) the electronic device receives an indication of a disconnection event for the first session from the second electronic device.

19. The electronic device of claim 17, wherein the one or more processors are further configured to execute instructions causing the one or more processors to:
transmit, during the first session, one or more images captured by the first image capture device to the second electronic device.

20. A non-transitory computer readable medium comprising computer readable instructions executable by one or more processors to:
enter, at a first electronic device, into a first state of a peer device advertising protocol;
detect a presence of a second electronic device in proximity to the first electronic device while in the first state of the peer device advertising protocol;
initiate a first session between the first electronic device and the second electronic device via a secure wireless peer-to-peer connection protocol;
receive, at the first electronic device during the first session, one or more images from a video image stream captured by a first image capture device of the second electronic device;
establish, at the first electronic device, a software process that periodically broadcasts a first session state indicator via the peer device advertising protocol, wherein the first session state indicator indicates whether the first session is currently active;
receive, at the software process of the first electronic device, a second session state indicator from the second electronic device via the peer device advertising protocol, wherein the second session state indicator indicates whether the first session is currently active; and
maintain, at the first electronic device, the first session until a session disconnection criterion is satisfied, wherein the session disconnection criterion is based, at least in part, on the first session state indicator or the second session state indicator, and wherein an interruption or pausing of the video image stream at the second electronic device does not satisfy the session disconnection criterion.
